(19) United States
(12) Patent Application Publication
(10) Pub. No.: US 2026/0229817 A1
(43) Pub. Date: Aug. 6, 2026

(54) ELECTRICAL CONNECTOR MODULE WITH ELASTIC LOCKING MEMBER AND ELECTRICAL CONNECTOR THEREOF

(71) Applicants: KUNSHAN AMPHENOL ZHENGRI ELECTRONICS CO., LTD., Kunshan City (CN); AMPHENOL LTW TECHNOLOGY CO., LTD., New Taipei City (TW)

(72) Inventors: Fan-Cheng HUANG, New Taipei City (TW); Kun-Te KO, New Taipei City (TW)

(21) Appl. No.: 19/088,742

(22) Filed: Mar. 24, 2025

(30) Foreign Application Priority Data
Feb. 6, 2025 (TW) 114104412

(51) Int. Cl. H01R 13/627; H01R 13/62

(52) U.S. Cl. CPC H01R 13/6271; H01R 13/6205

(57) ABSTRACT

An electrical connector includes a connector body, a movable annular collar, and an elastic locking member. The connector body includes a plug and a peripheral wall enclosing the plug. A plurality of hollow openings are defined on the peripheral wall. The movable annular collar is movably sleeved around the peripheral wall. The movable annular collar includes abutting blocks, pressing blocks, and grooves. The elastic locking member is positioned between the peripheral wall and the movable annular collar. The elastic locking member includes a ring arranged around the peripheral wall, a plurality of elastic locking arms, and a plurality of push-out ribs. The end of each elastic locking arm is positioned in a hollow opening and is pressed by the pressing block or positioned opposite the groove. The abutting blocks abut against the lower portions of the push-out ribs.

### BACKGROUND OF THE DISCLOSURE

### Technical Field

The technical field relates to an electrical connector, and particularly to an electrical connector module with an elastic locking member and the electrical connector thereof.

### Description of Related Art

A cable connection of the related art, involving male and female connectors, is often designed for quick connect and disconnect methods such as push-to-connect quick couplings, rotary locking mechanisms, or threaded fittings to achieve the purpose of connecting the male and female connectors.

However, although the push-to-connect quick couplings type of connectors is the most convenient method among the above-mentioned male and female connectors of the related art, they may not ensure the connection effect after docking, especially in cases where external forces, such as pulling or vibration, may cause separation and other issues.

Furthermore, other connectors with additional structures, such as rotary locks and threaded fittings, often take up space, which results in them being unsuitable for situations with limited space. This directly or indirectly limits the design of connectors for users (or product designers) due to existing specifications and functional limitations.

In view of the above drawbacks, the inventor proposes this disclosure based on his expert knowledge and elaborate researches in order to solve the problems of related art.

### SUMMARY OF THE DISCLOSURE

This disclosure provides an electrical connector module with an elastic locking member and the electrical connector thereof. When the movable annular collar is released, the push-out ribs elastically return to their original positions and push the abutting blocks downward until each pressing block presses against each elastic locking arm, so that the annular locking block is more firmly clamped between the plug and the elastic locking arms to achieve the advantages of automatic locking and multiple locking of the electrical connector module and the electrical connector of this disclosure.

In the embodiment of this disclosure, an electrical connector module includes a mating connector and a main connector. The mating connector includes an annular locking block. The main connector includes a connector body, a movable annular collar, and an elastic locking member. The connector body includes a plug and a peripheral wall enclosing the plug. A plurality of hollow openings are defined on the peripheral wall. The movable annular collar is movably sleeved around the peripheral wall. The movable annular collar includes a plurality of abutting blocks and a plurality of pressing blocks located on the inner periphery thereof, and a plurality of grooves are arranged below each of the pressing blocks. The elastic locking member is positioned between the peripheral wall and the movable annular collar. The elastic locking member includes a ring arranged around an outside of the peripheral wall, a plurality of elastic locking arms and a plurality of push-out ribs extending upward from the ring and arranged alternately with each other. The end of each elastic locking arm is positioned in each hollow opening and is either pressed by the pressing block or positioned opposite the corresponding groove, and the abutting blocks abut against the lower portions of the push-out ribs. When the movable annular collar is pulled upward, the abutting blocks push the push-out ribs toward the elastic locking arms. The end of each elastic locking arm is positioned opposite the grooves to make the annular locking block clamped between the plug and the plurality of elastic locking arms. The mating connector is inserted into the plug. When the movable annular collar is released, the plurality of push-out ribs elastically return to their original positions and push the abutting blocks downward until each pressing block engages with the corresponding elastic locking arm.

In the embodiment of this disclosure, an electrical connector includes a connector body, a movable annular collar, and an elastic locking member. The connector body includes a plug and a peripheral wall enclosing the plug. A plurality of hollow openings are defined on the peripheral wall. The movable annular collar is movably sleeved around the peripheral wall. The movable annular collar includes a plurality of abutting blocks and a plurality of pressing blocks located on the inner periphery thereof. A plurality of grooves are arranged below the pressing blocks. The elastic locking member is positioned between the peripheral wall and the movable annular collar. The elastic locking member includes a ring arranged around the peripheral wall, a plurality of elastic locking arms and a plurality of push-out ribs extending upward from the ring and arranged alternately with each other. The end of each elastic locking arm is positioned in each hollow opening and is pressed by the pressing block or positioned opposite the corresponding groove. The abutting blocks abut against the lower portions of the push-out ribs. When the movable annular collar is pulled upward, the abutting blocks push the push-out ribs to toward the elastic locking arms. The end of each elastic locking arm is positioned opposite the corresponding groove. When the movable annular collar is released, the push-out ribs elastically return to their original positions and push the plurality of abutting blocks downward until each pressing block engages with a corresponding elastic locking arm.

### BRIEF DESCRIPTION OF THE DRAWINGS

The features of the disclosure believed to be novel are set forth with particularity in the appended claims. The disclosure itself, however, may be best understood by reference to the following detailed description of the disclosure, which describes a number of exemplary embodiments of the disclosure, taken in conjunction with the accompanying drawings, in which:

FIG. 1 depicts an exploded schematic view of the electrical connector module according to this disclosure.

FIG. 2 depicts a cross sectional view of the electrical connector module according to this disclosure.

FIG. 3 depicts a perspective assembly view of the main connector according to this disclosure.

FIG. 4 depicts a perspective exploded schematic view of the main connector according to this disclosure.

FIG. 5 depicts another perspective exploded schematic view of the main connector according to this disclosure.

FIG. 6 depicts a schematic view illustrating the operation of the electrical connector module according to this disclosure.

FIG. 7 depicts a schematic view illustrating the operation of the main connector according to this disclosure.

FIG. 8 depicts another schematic view illustrating the operation of the main connector according to this disclosure.

FIG. 9 depicts another schematic view illustrating the operation of the electrical connector module according to this disclosure.

FIG. 10 depicts yet another schematic view illustrating the operation of the main connector according to this disclosure.

FIG. 11 depicts another schematic view illustrating the operation of the main connector according to this disclosure.

FIG. 12 depicts yet another schematic view illustrating the operation of the electrical connector module according to this disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

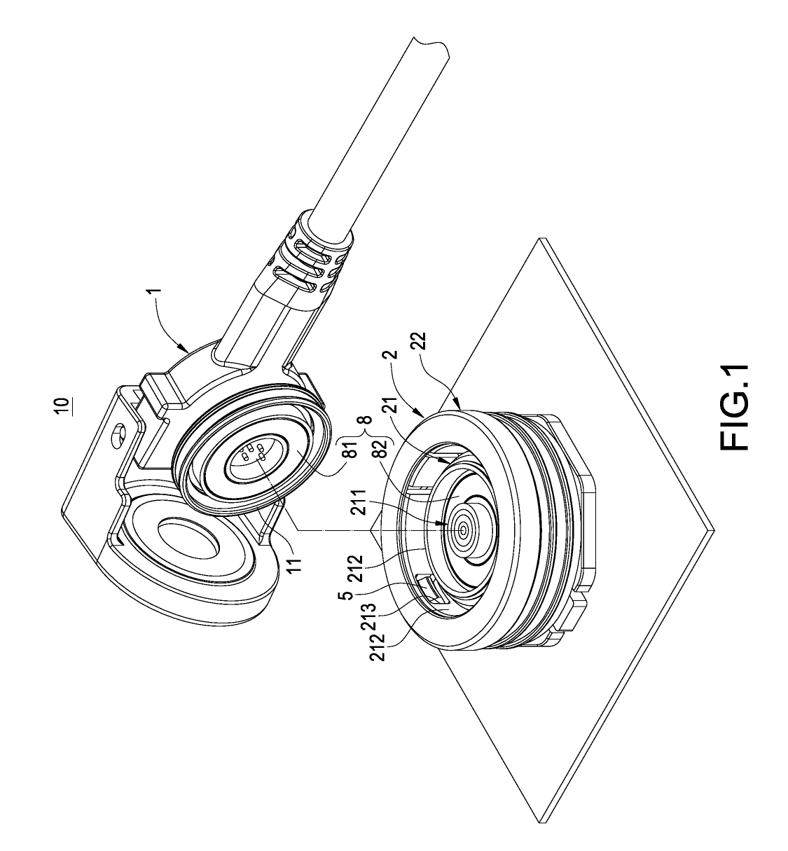

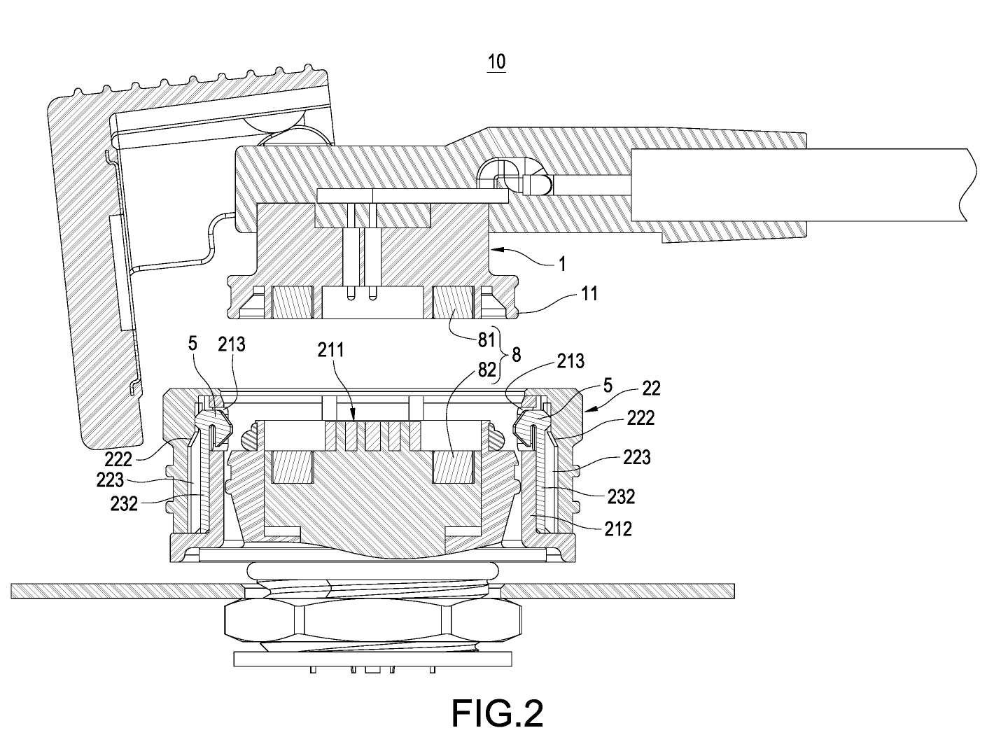

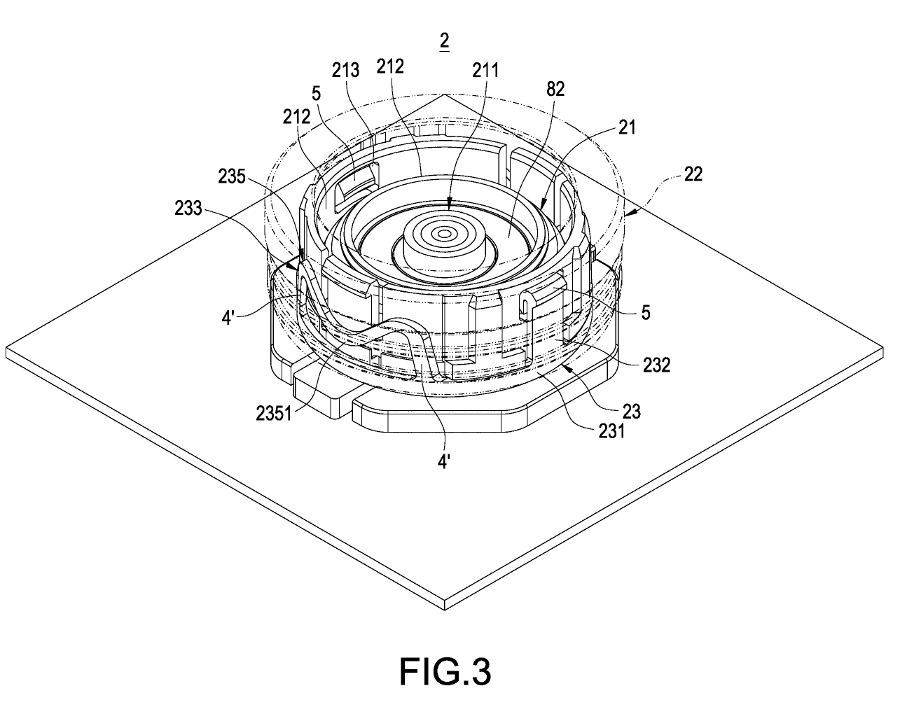

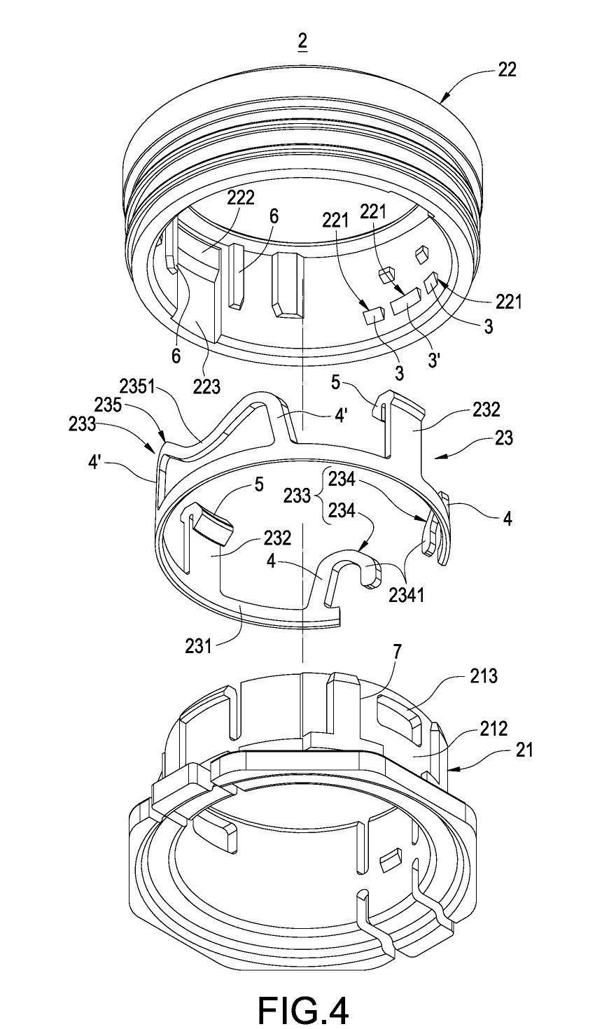

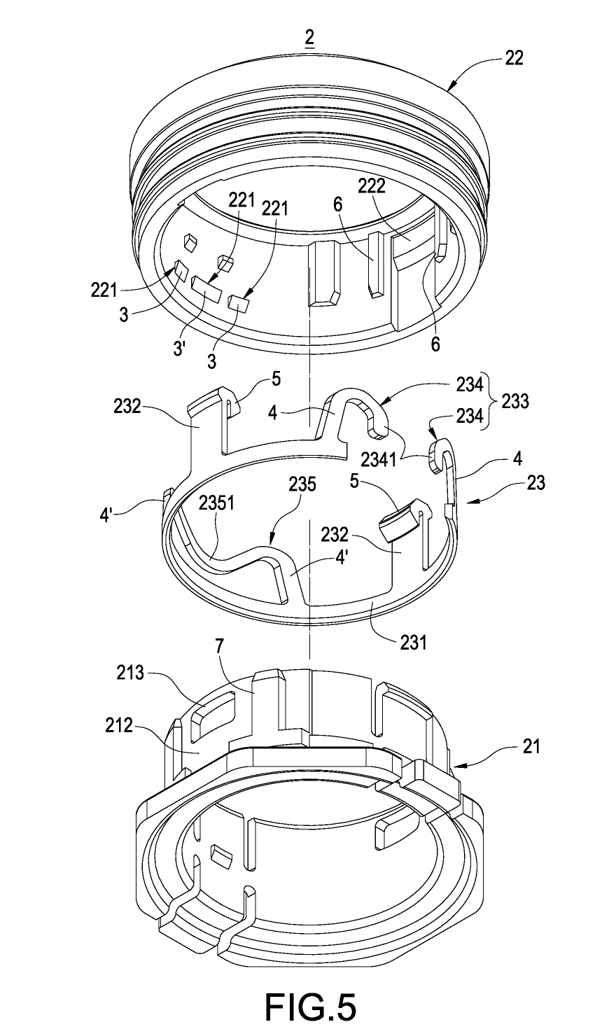

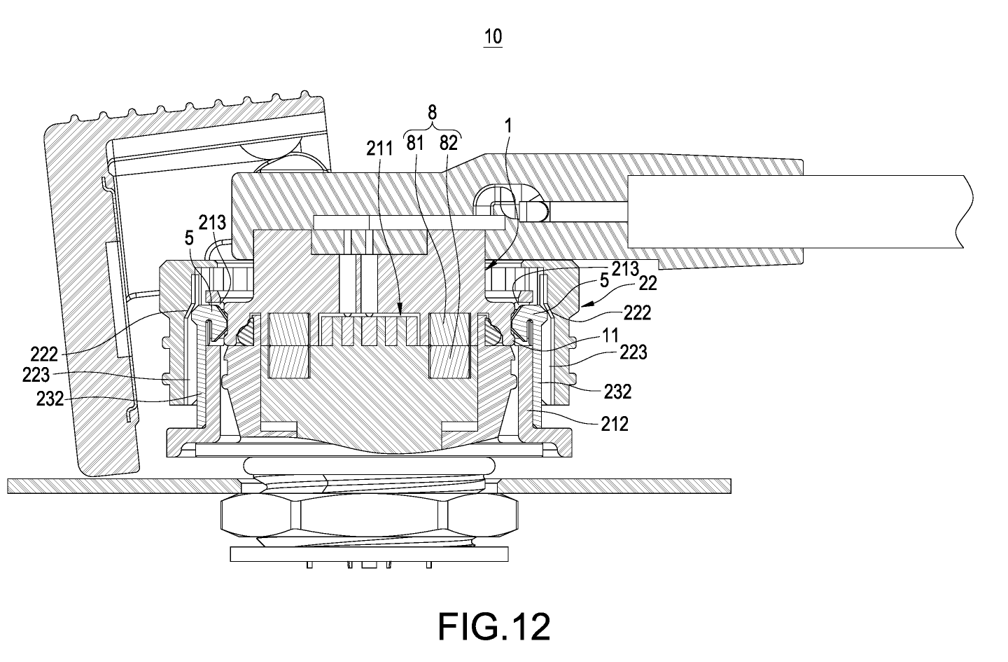

Please refer to FIGS. 1 to 12. This disclosure provides an electrical connector module with an elastic locking member and the electrical connector thereof. The electrical connector module 10 mainly includes a mating connector 1 and a main connector 2 that may be docked with each other. The main connector 2 mainly includes a connector body 21, a movable annular collar 22, and an elastic locking member 23.

As shown in FIGS. 1 to 2, 6, 9 and 12. The mating connector 1 is a female connector, but not limited thereto. The mating connector 1 may be a male connector. The mating connector 1 includes an annular locking block 11.

Please refer to FIGS. 1 to 12. The mating connector 2 in this disclosure is, but not limited to, a male connector. The main connector 2 mainly includes a connector body 21, a movable annular collar 22, and an elastic locking member 23.

The detailed description is as follows. The connector body 21 includes a plug 211 and a peripheral wall 212 enclosing the plug 211, and a plurality of hollow openings 213 are defined on the peripheral wall 212. The plug 211 in this embodiment is a male connector, but this is not limited thereto. The main connector 2 is a female connector, and the plug 211 is a female plug.

Moreover, the movable annular collar 22 is movably sleeved around (movably sheathes) the peripheral wall 212. The movable annular collar 22 includes a plurality of abutting blocks 221 and a plurality of pressing blocks 222 located on the inner periphery thereof, and a plurality of grooves 223 are arranged below the pressing blocks 222. The abutting blocks 221 include inclined blocks 3, 3’. The thickness of each inclined block 3, 3' gradually decreases in the direction away from the pressing blocks 222.

Moreover, the movable annular collar 22 includes a plurality of sliders 6 extending from either the inner periphery thereof or the outer periphery of the peripheral wall 212. A plurality of longitudinal sliding grooves 7 are arranged on the other one of the inner periphery of the movable annular collar 22 and the outer periphery of the peripheral wall 212. The sliders 6 are slidably connected to the longitudinal sliding grooves 7, allowing the movable annular collar 22 to slide along the longitudinal sliding grooves 7 through the sliders 6 to move up and down relative to the peripheral wall 212.

Furthermore, the elastic locking member 23 is positioned between the peripheral wall 212 and the movable annular collar 22. The elastic locking member 23 includes a ring 231 arranged around the peripheral wall 212, a plurality of elastic locking arms 232 and a plurality of push-out ribs 233 extending upward from the ring 231 and arranged alternately with each other. The end of each elastic locking arm 232 is positioned correspondingly in each hollow opening 213 and is either pressed by the pressing blocks 222 or positioned opposite the corresponding groove 223. The abutting blocks 221 abut against the lower portions of the push-out ribs 233.

In this embodiment, the numbers of the pressing blocks 222, the grooves 223, the hollow openings 213, the elastic locking arms 232, the sliders 6, and the longitudinal sliding grooves 7 are two, respectively, but this is not limited thereto. Each slider 6 includes a pair of vertical ribs extending from the inner periphery of the movable annular collar 22 and arranged on both sides of each pressing block 222. The longitudinal sliding grooves 7 are arranged on the outer periphery of the peripheral wall 212. The pair of vertical ribs may slide up and down in the longitudinal sliding grooves 7. The vertical ribs are arranged on two sides of each pressing block 222, thereby stabilizing the position of the pressing block 222 and the groove 223, so that the end of each elastic locking arm 232 may be pressed by each pressing block 222 or positioned opposite the corresponding groove 223. Additionally, the sliders 6 and the longitudinal sliding grooves 7 may be arranged reversely. That is, each slider 6 may be extended from the outer periphery of the peripheral wall 212, and the longitudinal sliding grooves 7 may be arranged on the inner periphery of the movable annular collar 22.

Further, each elastic locking arm 232 includes a hook 5 located at the end thereof, and each hook 5 is located in the hollow opening 213 and protrudes from the hollow opening 213. The annular locking block 11 is clamped between the plug 211 and each hook 5.

The number of the push-out ribs 233 in this embodiment is two, but this is not a limitation. One of the push-out ribs 233 includes a pair of inverted J-shaped ribs 234 with their openings facing inward. The inverted J-shaped rib 234 includes a vertical section 4 extending upward from the ring 231 and a U-shaped section 2341 located at the end of the vertical section 4. Each of the inclined blocks 3 abuts against the lower portion of each U-shaped section 2341. That is, each inclined block 3 abuts against the lower portion of each inverted J-shaped rib 234.

Additionally, as shown in FIG. 11, when the pair of inverted J-shaped ribs 234 elastically return to their original positions, the spacing H defined between the vertical sections 4 is gradually reduced in the direction toward the U-shaped sections 2341, and the vertical sections 4 are inclined inwardly. Therefore, as shown in FIG. 8, when the movable annular collar 22 is pulled upward, the abutting blocks 221 pushes the U-shaped sections 2341 upward to straighten the vertical sections 4. That is, the abutting blocks 221 push the vertical sections 4 of the push-out ribs 233 toward the elastic locking arms 232, so that the push-out rib 233 is dragged by the ring 231 to provide force for the elastic locking arms 232 to be disengaged from the hollow opening 213. On the contrary, when the pair of inverted J-shaped ribs 234 elastically return to their original positions, the vertical sections 4 tilt inwardly and return to their original positions, so that the push-out ribs 233 are dragged by the ring 231 to provide force for the elastic locking arms 232 to be inserted into the hollow openings 213.

Moreover, another push-out rib 233 includes an M-shaped rib 235, and the M-shaped rib 235 includes a V-shaped section 2351 in the middle thereof. The inclined block 3' abuts against the lower portion of the V-shaped section 2351. The M-shaped rib 235 includes two vertical sections 4' located on two sides thereof. One end of the vertical section extends from the ring 231, and the other end of the vertical section extends from the end of the V-shaped section 2351.

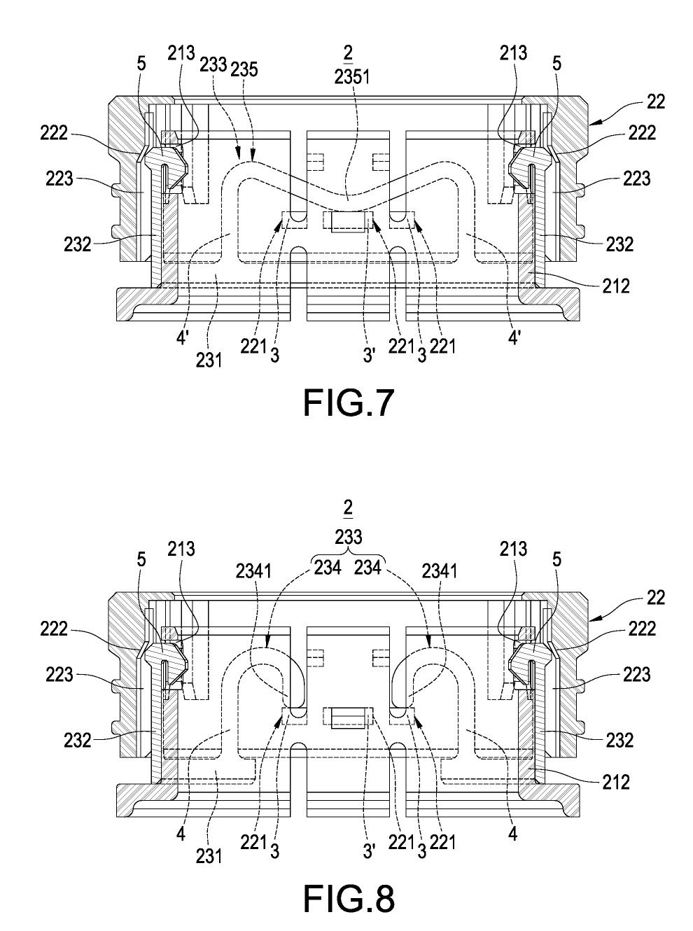

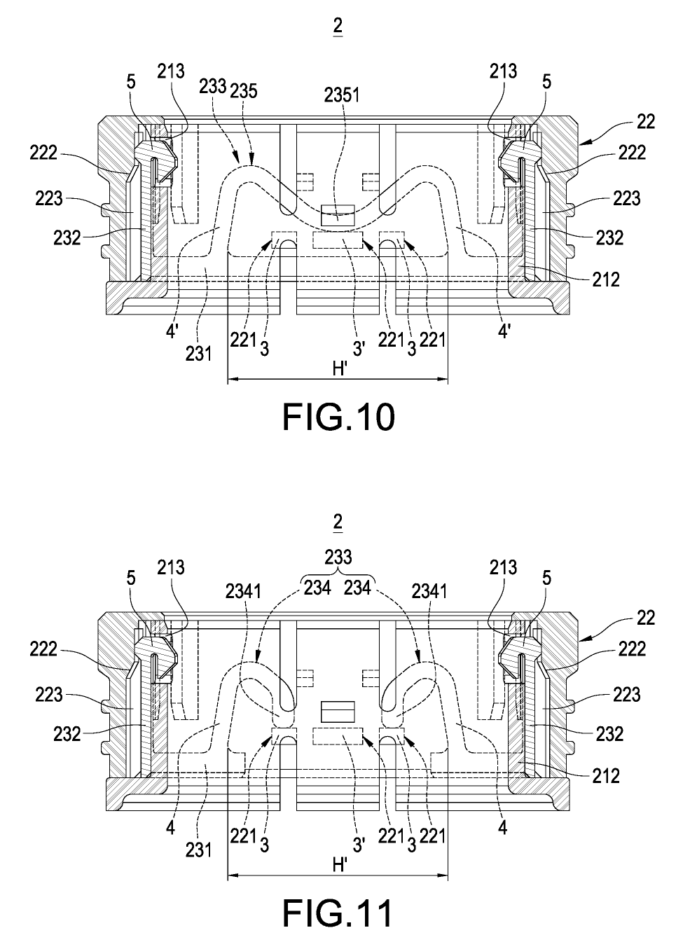

Furthermore, as shown in FIG. 10, when the M-shaped rib 235 elastically returns to its original position, the spacing H’ defined between the vertical sections 4’ is gradually reduced in the direction toward the V-shaped section 2351, and the vertical sections 4’ are inclined inwardly. Therefore, as shown in FIG. 7, when the movable annular collar 22 is pulled upward, the abutting blocks 221 push the V-shaped section 2351 upward to straighten the vertical sections 4’. That is, the abutting blocks 221 push the vertical sections 4 of the push-out ribs 233 toward the elastic locking arms 232, so that the push-out ribs 233 are dragged by the ring 231 to provide force for the elastic locking arms 232 to be disengaged from the hollow opening 213. On the contrary, when the M-shaped rib 235 returns to its original positions, the vertical sections 4’ tilt inwardly and return to their original positions, so that the push-out ribs 233 are dragged by the ring 231 to provide force for the elastic locking arms 232 to be inserted into the hollow openings 213.

Additionally, the ring 231 of this embodiment includes a C-shaped ring. The pair of inverted J-shaped ribs 234 is arranged at the two ends of the C-shaped ring. The M-shaped rib 235 is arranged in the middle of the C-shaped ring, but this is not limited thereto. The ring 231 may also be an O-shaped ring. The push-out ribs 233 may all be a pair of inverted J-shaped ribs 234 or all be M-shaped ribs 235.

As shown in FIGS. 1 to 3, 6, 9 and 12, the electrical connector module 10 further includes a magnetic set 8. The magnetic set 8 includes at least one magnet 81 installed on either the mating connector 1 or the plug 211 and at least one magnetically attracted member 82 installed on the other one of the mating connector 1 and the plug 211. When the mating connector 1 is inserted into the plug 211, the magnet 81 and the magnetically attracted member 82 are magnetically attracted to each other, achieving the advantage of quick docking of the mating connector 1 and the plug 211.

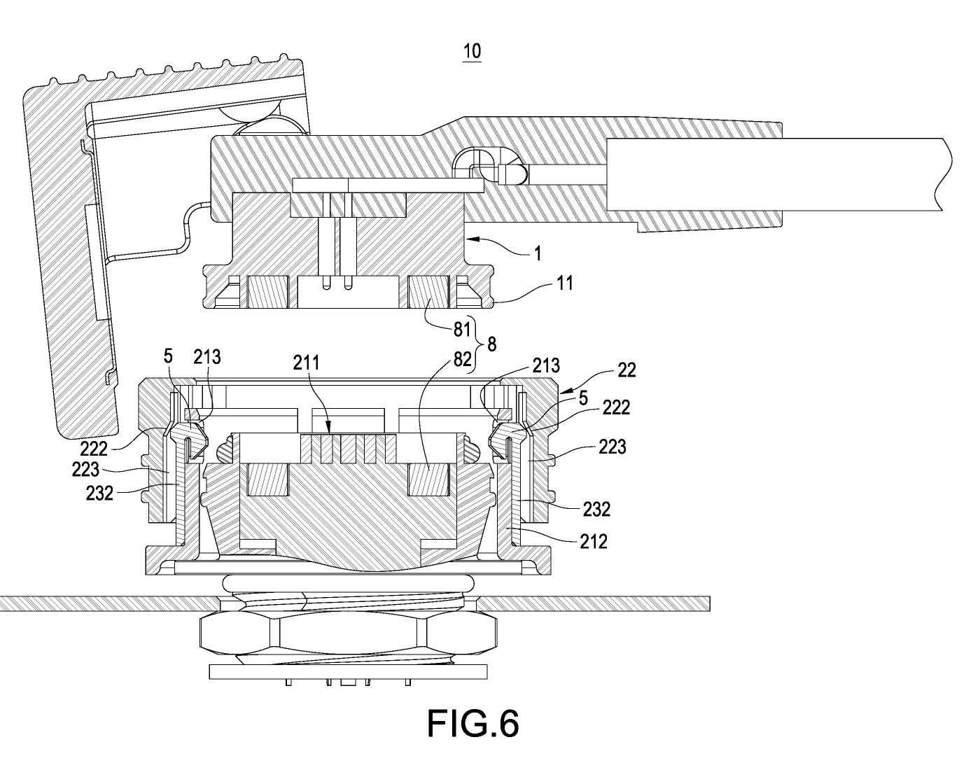

The operation of the electrical connector module 10 and the electrical connector is described as follows. As shown in FIGS. 6 to 9, when the movable annular collar 22 is pulled upward, the abutting blocks 221 push the push-out ribs 233 toward the elastic locking arms 232. The end of each elastic locking arm 232 is positioned opposite to each groove 223 to allow the annular locking block 11 to easily push the elastic locking arm 232 into the groove 223 until the annular locking block 11 is inserted between the plug 211 and the elastic locking arm 232. The elastic locking arms 232 return to their original positions, the annular locking block 11 is clamped between the plug 211 and the elastic locking arms 232. At the same time, the magnetic set 8 drives the mating connector 1 to quickly dock with the plug 211.

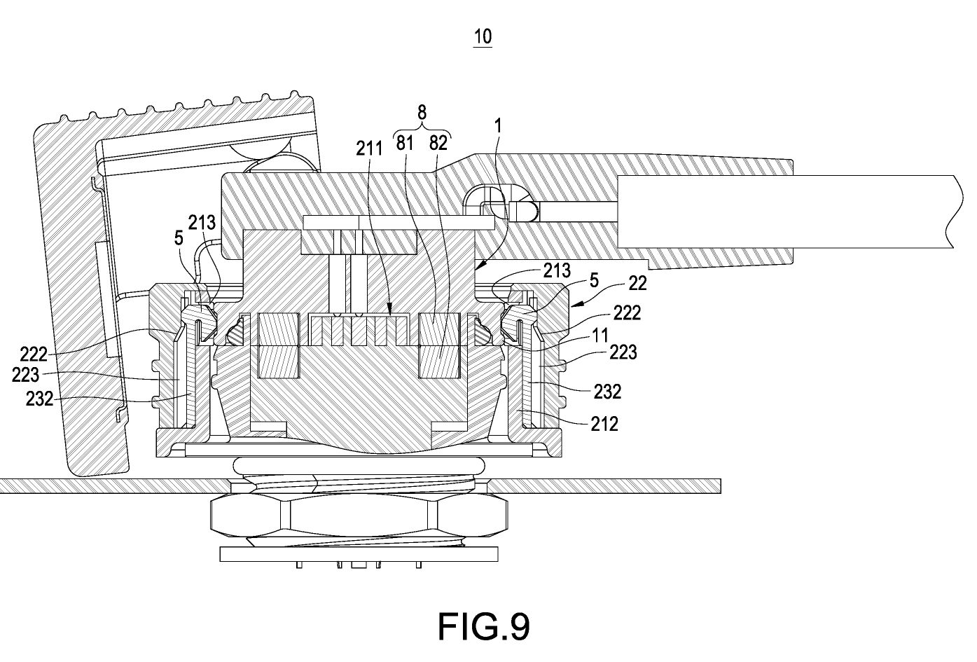

Then, as shown in FIGS. 9 to 11, when the movable annular collar 22 is released, the push-out ribs 233 elastically return to their original positions and push the abutting blocks 221 downward until each pressing block 222 presses against each elastic locking arm 232. The vertical sections 4 tilt inwardly and return to their original positions, and the push-out ribs 233 are dragged by the ring 231 to provide force for the elastic locking arms 232 to be inserted into the hollow openings 213. Thus, the annular locking block 11 is more firmly clamped between the plug 211 and the elastic locking arms 232 to achieve an automatic locking function. Simultaneously, the first locking of the mating connector 1 and the plug 211 is achieved by the magnetic set 8, and the second locking of the mating connector 1 and the plug 211 is achieved by the elastic locking member 23. Therefore, the advantages of automatic locking and multiple locking of the electrical connector module 10 and the electrical connector of this disclosure may be achieved.

Similarly, as shown in FIGS. 12 and 7 to 8, when the above automatic locking is to be unlocked, the movable annular collar 22 is pulled upward, and the abutting blocks 221 push the U-shaped sections 2341 upward to straighten the vertical sections 4. The push-out ribs 233 are dragged by the ring 231 to provide force for the elastic locking arms 232 to be disengaged from the hollow opening 213. At this time, the mating connector 1 is pulled upward, and the annular locking block 11 may easily push out the elastic locking arm 232 to disengage the annular locking block 11 from the clamping of the elastic locking arm 232. Thus, the mating connector 1 is separated from the plug 211.

Moreover, the vertical sections 4 tilt inwardly and return to their original positions in the above-mentioned automatic locking state, and the push-out ribs 233 are dragged by the ring 231 to provide force for the elastic locking arms 232 to be inserted into the hollow openings 213. In emergency situations, when the user pulls the mating connector 1 upward with a force that exceeds the force provided by the push-out ribs 233 to the elastic locking arm 232 and the elastic force of the elastic locking arm 232 itself, the annular locking block 11 may be disengaged from the clamping of the elastic locking arm 232 to detach the mating connector from the plug 211.

While this disclosure has been described by means of specific embodiments, numerous modifications and variations may be made thereto by those skilled in the art without departing from the scope and spirit of this disclosure set forth in the claims.

What is claimed is:

1. An electrical connector module, comprising:
a mating connector, comprising an annular locking block; and
a main connector, comprising:
a connector body, comprising a plug and a peripheral wall enclosing the plug, wherein a plurality of hollow openings are defined on the peripheral wall;
a movable annular collar, movably sleeved around the peripheral wall, comprising a plurality of abutting blocks and a plurality of pressing blocks located on an inner periphery thereof, wherein a plurality of grooves are arranged below the pressing blocks; and
an elastic locking member, positioned between the peripheral wall and the movable annular collar, comprising a ring arranged around the peripheral wall, a plurality of elastic locking arms and a plurality of push-out ribs extending upward from the ring and arranged alternately with each other, wherein an end of each elastic locking arm is positioned correspondingly in each hollow opening and is pressed by a pressing block or positioned opposite to each groove, and the abutting blocks abut against lower portions of the push-out ribs;
wherein, when the movable annular collar is pulled upward, the abutting blocks push the push-out ribs toward the elastic locking arms; the end of each elastic locking arm is positioned opposite to each groove to clamp the annular locking block between the plug and the elastic locking arms; the mating connector is inserted into the plug; when the movable annular collar is released, the push-out ribs elastically return to original positions and push the abutting blocks downward until each pressing block is engaged with each elastic locking arm.

2. The electrical connector according to claim 1, wherein the push-out ribs are a pair of inverted J-shaped ribs with openings facing inward, and the abutting blocks are a pair of inclined blocks abutting ends of the inverted J-shaped ribs, and a thickness of each inclined block gradually decreases in a direction away from the pressing blocks.

3. The electrical connector module according to claim 2, wherein the inverted J-shaped rib comprises a vertical section extending upward from the ring and a U-shaped section located at an end of the vertical section; each inclined block abuts against a lower portion of each U-shaped section; and when the inverted J-shaped ribs elastically return to original positions, a spacing defined between two vertical sections is gradually reduced in a direction toward the U-shaped sections, and the vertical sections are inclined inwardly.

4. The electrical connector module according to claim 3, wherein the ring is a C-shaped ring, and the pair of inverted J-shaped ribs is arranged at two ends of the C-shaped ring.

5. The electrical connector module according to claim 1, wherein the push-out rib is an M-shaped rib, and the M-shaped rib comprises a V-shaped section in a middle thereof; the abutting block is an inclined block abutting a lower portion of the V-shaped section; and a thickness of the inclined block gradually decreases in a direction away from the pressing blocks.

6. The electrical connector module according to claim 5, wherein the M-shaped rib comprises two vertical sections located on two sides thereof; one ends of the vertical sections extends from the ring, and other ends of the vertical section extends from an end of the V-shaped section; and when the M-shaped rib returns to original position, a spacing defined between the vertical sections is gradually reduced in a direction toward the V-shaped section, and the vertical sections are inclined inwardly.

7. The electrical connector module according to claim 6, wherein the ring is a C-shaped ring, and the M-shaped rib is disposed at a middle part of the C-shaped ring.

8. The electrical connector module according to claim 1, wherein each elastic locking arm comprises a hook located at an end thereof, and the hook is located in each hollow opening and protrudes from each hollow opening, and the annular locking block is clamped between the plug and the hook.

9. The electrical connector module according to claim 1, wherein the movable annular collar comprises a plurality of sliders extended from one of an inner periphery thereof and an outer periphery of the peripheral wall, and a plurality of longitudinal sliding grooves are arranged on another one of the inner periphery thereof and the outer periphery of the peripheral wall, and the sliders are slidably connected to the longitudinal sliding grooves.

10. The electrical connector module according to claim 1, further comprising a magnetic set, wherein the magnetic set comprises at least one magnet installed on one of the mating connector and the plug and at least one magnetically attracted member installed on another one of the mating connector and the plug; and when the mating connector is inserted into the plug, the magnet and the magnetically attracted member are magnetically attracted to each other.

11. An electrical connector, comprising:
a connector body, comprising a plug and a peripheral wall enclosing the plug, wherein a plurality of hollow openings are defined on the peripheral wall;
a movable annular collar, movably sleeved around the peripheral wall, the movable annular collar comprising a plurality of abutting blocks and a plurality of pressing blocks located on an inner periphery thereof, wherein a plurality of grooves are arranged below the pressing blocks; and
an elastic locking member, positioned between the peripheral wall and the movable annular collar, comprising a ring arranged around the peripheral wall, a plurality of elastic locking arms and a plurality of push-out ribs extending upward from the ring and arranged alternately with each other, wherein an end of each elastic locking arm is positioned correspondingly in each hollow opening and is pressed by a pressing block or positioned opposite to each groove, and the abutting blocks abut against lower portions of the push-out ribs;
wherein, when the movable annular collar is pulled upward, the abutting blocks push the push-out ribs toward the elastic locking arms; the end of each elastic locking arm is positioned opposite to each groove; and when the movable annular collar is released, the push-out ribs elastically return to original positions and push the abutting blocks downward until each pressing block is engaged with each elastic locking arm.

12. The electrical connector according to claim 11, wherein the push-out ribs are a pair of inverted J-shaped ribs with openings facing inward, and the abutting blocks are a pair of inclined blocks abutting ends of the inverted J-shaped ribs, and a thickness of each inclined block gradually decreases in a direction away from the pressing blocks.

13. The electrical connector according to claim 12, wherein the inverted J-shaped rib comprises a vertical section extending upward from the ring and a U-shaped section located at an end of the vertical section; each of the inclined blocks abuts against a lower portion of each U-shaped section; and when the inverted J-shaped ribs return to original positions, a spacing defined between two vertical sections is gradually reduced in a direction toward the two U-shaped sections and is inclined inwardly.

14. The electrical connector according to claim 13, wherein the ring is a C-shaped ring, and the pair of inverted J-shaped ribs is arranged at two ends of the C-shaped ring.

15. The electrical connector according to claim 11, wherein the push-out rib is an M-shaped rib, and the M-shaped rib comprises a V-shaped section in a middle thereof; the abutting block is an inclined block abutting a lower portion of the V-shaped section; and a thickness of the inclined block gradually decreases in a direction away from the pressing blocks.

16. The electrical connector module according to claim 15, wherein the M-shaped rib comprises two vertical sections located on two sides thereof; one ends of the vertical section extends from the ring, and other ends of the vertical section extend from ends of the V-shaped section; and when the M-shaped rib returns to original position, a spacing defined between the vertical sections is gradually reduced in a direction toward the V-shaped section, and the vertical sections are inclined inwardly.

17. The electrical connector according to claim 16, wherein the ring is a C-shaped ring, and the M-shaped rib is disposed at a middle part of the C-shaped ring.

18. The electrical connector according to claim 11, wherein each elastic locking arm comprises a hook located at an end thereof, and the hook is located in each hollow opening and protrudes from each hollow opening.

19. The electrical connector according to claim 11, wherein the movable annular collar comprises a plurality of sliders extended from one of an inner periphery thereof and an outer periphery of the peripheral wall, and a plurality of longitudinal sliding grooves are arranged on another one of the inner periphery thereof and the outer periphery of the peripheral wall, and the sliders are slidably connected to the longitudinal sliding grooves.
